(19) United States
(12) Patent Application Publication
(10) Pub. No.: US 2007/0131625 A1
(43) Pub. Date: Jun. 14, 2007

(54) Methods of inhibiting biogenic sulfide formation in aqueous systems

(75) Inventors: Wendy A. Segal, Burlington, NJ (US); Nicholas R. Blandford, Willow Grove, PA (US)

Correspondence Address: DUANE MORRIS, LLP;IP DEPARTMENT, 30 SOUTH 17TH STREET, PHILADELPHIA, PA, 19103-4196, US

(73) Assignee: General Electric Company

(21) Appl. No.: 11/301,074

(22) Filed: Dec. 12, 2005

(51) Int. Cl. C02F 1/76

(52) U.S. Cl. 210/754

(57) ABSTRACT

The present invention relates to methods for inhibiting biogenic sulfide formation in an aqueous system, which include adding to the aqueous system an effective amount for the purpose of a combination of a chlorate compound and a nitrate compound. The invention includes utilizing the enhanced effect resulting from combining inorganic oxidizing chemicals for superior prevention of biogenic sulfide formation in wastewater systems.

### FIELD OF THE INVENTION

The present invention relates to a fast-acting, aqueous phase chemical treatment for inhibiting the formation of biogenic sulfide in aqueous systems.

### BACKGROUND OF THE INVENTION

The reactivity between various aldehydes and sulfidic compounds (H₂S, mercaptans, etc.) has been known in the art for some time. For example, Marks in U.S. Pat. No. 1,991,765 discloses a method of reacting hydrogen sulfide and an aldehyde in an aqueous solution having a pH between 2 and 12 at a temperature between substantially 20° C. and 100° C. After Marks' disclosure in 1935, many patents appeared disclosing the use of aldehydes during acid cleaning of iron sulfide deposits, including U.S. Pat. Nos. 2,606,873; 3,514,410; 3,585,069; 3,669,613; 4,220,550; 4,289,639; and 4,310,435. Consumption of the hydrogen sulfide liberated by acidification of sulfide-containing deposits increased the safety of such operations. Decreased corrosivity of the aldehyde-containing acids is also disclosed in the prior art, sometimes with the addition of ancillary corrosion inhibitors.

Menaul in U.S. Pat. No. 2,426,318 discloses a method of inhibiting the corrosive action of natural gas and oil containing soluble sulfides on metals by utilizing an aldehyde, preferably formaldehyde.

Roehm in U.S. Pat. No. 3,459,852 discloses a process for deodorizing and reducing the biochemical demand of an aqueous solution which contains at least one compound of hydrogen sulfide and compounds containing the —SH group. Roehm's process comprises mixing the solution with a sulfide-active alpha, beta unsaturated aldehyde or ketone in an amount sufficient to form sulfur-containing reaction product of the sulfide active aldehyde or ketone. More specifically, Roehm's invention resides in the use of compounds having an alpha, beta unsaturated aldehyde or ketone moiety as the reactive portion: Two such sulfide-active compounds disclosed by Roehm are acrolein and 3-buten-2-one.

Formaldehyde, formaldehyde with SO₃₋², and acrolein are all commercially used hydrogen sulfide (H₂S) scavengers. However, formaldehyde produces a solid reaction product and reverts readily to formaldehyde and free H₂S. Acrolein is more expensive than formaldehyde as well as extremely toxic and dangerous to handle. The use of SO₃₋² with formaldehyde eliminates the re-release of H₂S but not solids formation.

Despite the prior art approaches to H₂S scavenging, the provision of a single compound or group of compounds capable of providing the H₂S scavenging function while not producing a solid reaction product and without stringent handling problems is highly desirable, from a commercial point of view. Such a compound or compounds would provide suitable H₂S scavengers for systems where solids must be avoided. These needs are effectively met by utilization of the hydrogen sulfide inhibiting methods of the present invention.

### SUMMARY OF THE INVENTION

The present invention relates to a method for inhibiting biogenic (produced by living organisms or biological processes) sulfide formation in an aqueous system, which method comprises adding to the aqueous system an effective amount for the purpose of a combination of a chlorate compound and a nitrate compound. The invention comprises utilizing the enhanced effect resulting from combining inorganic oxidizing chemicals for superior prevention of biogenic sulfide formation in wastewater systems.

### DESCRIPTION OF THE PREFERRED EMBODIMENTS

The present invention utilizes a combination of a nitrate compound and a chlorate compound, thereby creating a synergistic effect superior to that of either compound alone, to inhibit or prevent the formation of biogenic sulfide in aqueous systems. Sulfate reducing bacteria (SRB) in aqueous systems convert sulfur containing species of higher oxidation states to sulfides (S²⁻), which form hydrogen sulfide gas (H₂S). H₂S is a highly toxic and corrosive gas in concentrated amounts, and a nuisance odor in very low (ppb) amounts. Formation of sulfide then creates a more hospitable environment for SRB growth, due to its reducing effect. It is well known that in the presence of a nitrate compound, S²⁻ formation by SRB is inhibited with no negative effect on their growth. Chlorate is well known as an herbicide, and somewhat known as an energy source for bacteria along with nitrate. However, chlorate alone and in combination with nitrate demonstrated no negative effect on bacterial growth in laboratory bottle tests, and alone did not significantly inhibit biogenic sulfide formation in laboratory bottle tests. By the method of the present invention, when a nitrate compound is combined with a chlorate compound, S²⁻ formation by SRB is inhibited at a much lower dosage than with a nitrate or chlorate compound alone. Along with this enhanced result, there is no negative effect on bacterial growth.

For the testing of the present invention, bottle tests consisted of 100 mL autoclaved ATCC media#1249 modified to contain 250 PPM SO₄ and sealed with a septum stopper and aluminum crimp cap. Aerobic bacteria of a mixed population were cultivated for about 24-52 hours prior to inoculation to the test bottle. Sulfate reducing bacteria of the species Desulfivibrio desulfuricans were cultivated anaerobically for at least 5 days prior to the test and inoculated to the media about 4 hours after the aerobic bacteria. Treatments were added, and the bottles were incubated either at ambient room temperature or 35° C. At least five bottles were left untreated as controls, and triplicates were done for each treatment dosage.

One control was measured after 15 hours of incubation, and another control was measured about two hours thereafter until sulfide generation was observed. This typically involved 15 hours for 35° C. incubation, and longer for ambient room temperature incubation. Once sulfide generated in the controls, the entire set of test bottles were put on ice for about three hours to stop any further biogenic production of sulfide, and remained on ice during sampling for sulfide measurement. Aliquots of 25 mL were drawn from the test bottle and introduced into a bottle containing 0.125 mL 24% zinc acetate, swirled, and 1 mL of 1N NaOH was added to the sample. The samples were then measured for sulfide within 48 hours. The method of sulfide measurement employed was methylene blue chemistry.

Bottle test efficacy studies utilizing both aerobic bacteria, and anaerobic SRB in suitable nutrient media were conducted to establish the enhanced effect of combining the nitrate and chlorate compounds. S²⁻ formation by SRB was measured for each treatment as well as non-treated controls. All dosages were done in triplicate. Various ratios were evaluated to establish a synergistic range for each compound. Results are shown in Tables I-IV, below.

TABLE I
Results = PPM S²⁻generated by SRB

| | Solution Dosage (PPM) | | | | | |
|---|---|---|---|---|---|---|
| Solution Strength | 0 | 5 | 10 | 20 | 50 | 100 |
| 10%NaClO₃:25%NaNO₃ | 59.21667 | 60.95833 | 45.28333 | 52.25 | 8.011667 | 2.438333 |
| 20%NaClO₃:17%NaNO₃ | 59.21667 | 69.66667 | 59.21667 | 43.54167 | 27.86667 | 13.23667 |
| 30%NaClO₃:9%NaNO₃ | 59.21667 | 62.7 | 62.7 | 33.09167 | 43.54167 | 36.575 |
| 34%NaNO₃ | 59.21667 | 53.99167 | 52.25 | 66.18333 | 55.73333 | 45.28333 |
| 40%NaClO₃ | 59.21667 | 55.73333 | 55.73333 | 52.25 | 41.8 | 45.28333 |

TABLE II
Results = PPM S²⁻generated by SRB

| | Solution Dosage (PPM) | | | | | |
|---|---|---|---|---|---|---|
| Solution Strength | 0 | 5 | 10 | 20 | 50 | 100 |
| 20%NaClO₃:17%NaNO₃ | 67.925 | 83.6 | 83.6 | 83.6 | 83.6 | 24.38333 |
| 10%NaClO₃:25%NaNO₃ | 67.925 | 78.375 | 76.63333 | 81.85833 | 76.63333 | 9.056667 |
| 4%NaClO₃:31%NaNO₃ | 67.925 | 83.6 | 83.6 | 73.15 | 76.63333 | 59.21667 |
| 34%NaNO₃ | 67.925 | | | | 83.6 | 73.15 |
| 40%NaClO₃ | 67.925 | | | 73.15 | 73.15 | 73.15 |

Tables I and II demonstrate the efficacy of the combination of chlorate and nitrate to inhibit biogenic sulfide production. Three ratios of chlorate to nitrate were evaluated, showing that the most synergistic ratio occurs when the amount of chlorate is less than nitrate. It is also evident that chlorate itself is not effective for inhibiting biogenic sulfide production, and enhances the effect of nitrate alone. Both tables show the upper and lower thresholds for chlorate addition to nitrate.

TABLE III
Results = PPM S²⁻generated by SRB

Solution Dosage (PPM)

| Solution Strength | 0 | 20 | 50 | 100 |
|---|---|---|---|---|
| 10%NaClO₃:25%NaNO₃ | 75.24 | 80 | 80 | 0.33 |
| 36%Ca(NO₃)₂ | 75.24 | 70 | 80 | 45 |
| 10%NaClO₃:19%Ca(NO₃)₂ | 75.24 | 80 | 70 | 4 |
| 39%Mg(NO₃)₂ | 75.24 | 70 | 70 | 70 |
| 10%NaClO₃:29%Mg(NO₃)₂ | 75.24 | 60 | 70 | 0 |

TABLE IV

| | | | | Petrifilm Total | |
|---|---|---|---|---|---|
| | | PPM Solution | PPM S²⁻ | Aerobic Count | SRB Growth MPN |
| Test | Treatment | Dosage | Generated | (cfu/mL) | Method (cfu/mL) |
| 1 | None | 0 | 0.84 | 1.00E+03 | 1.00E+07 |
| 1 | None | 0 | 1.57 | 1.00E+06 | 1.00E+07 |
| 1 | 40%NaClO₃ | 5 | 0 | 1.00E+08 | 1.00E+07 |
| 1 | 40%NaClO₃ | 10 | 0 | 1.00E+09 | 1.00E+07 |
| 1 | 40%NaClO₃ | 20 | 0 | 1.00E+07 | 1.00E+07 |
| 4 | None | 0 | 47 | 1.00E+07 | 1.00E+08 |
| 4 | 10%NaClO₃:25%NaNO₃ | 50 | 7.32 | 1.00E+06 | 1.00E+08 |
| 4 | 10%NaClO₃:25%NaNO₃ | 100 | 1.05 | 1.00E+06 | 1.00E+08 |
| 4 | 20%NaClO₃:17%NaNO₃ | 100 | 8.36 | 1.00E+06 | 1.00E+09 |
| 9 | None | 0 | 94.05 | 1.00E+07 | 1.00E+09 |
| 9 | None | 0 | 94.05 | 1.00E+07 | 1.00E+09 |
| 9 | 10%NaClO₃:25%NaNO₃ | 50 | 11.27 | 1.00E+07 | 1.00E+09 |
| 9 | 10%NaClO₃:25%NaNO₃ | 100 | 5.02 | 1.00E+07 | 1.00E+09 |

Table III demonstrates that the synergy between chlorate and nitrate is not dependant on the metal portion of the nitrate compound. Chlorate behaved synergistically with all metal nitrate compounds evaluated. Table IV shows both aerobic and anaerobic growth evaluations for treated and non-treated bottle tests. For each bottle test, the treated bottle that showed the least amount of S²⁻ generated was evaluated to determine if the effect was due to poor bacterial growth. Non-treated bottles were measured for comparison. Aerobic bacterial growth was measured using serial dilutions and plated on Petrifilm™ Aerobic Count Plates. Anaerobic (SRB) growth was measured using MPN serial dilutions into sterile, anoxic media containing an iron nail to precipitate iron sulfide. In all evaluations, no evidence of aerobic or anaerobic bacterial growth inhibition occurred along with inhibition of sulfide, as compared to the controls.

In a preferred embodiment, the chlorate compound is a metal chlorate (NaClO₃ particularly preferred), while the nitrate compound is a metal nitrate (NaNO₃ particularly preferred).

While the present invention has been described with respect to particular embodiment thereof, it is apparent that numerous other forms and modifications of the invention will be obvious to those skilled in the art. The appended claims and this invention generally should be construed to cover all such obvious forms and modifications, which are within the true spirit and scope of the present invention.

We claim:

1. A method for inhibiting biogenic sulfide formation in an aqueous system, which comprises adding to the aqueous system an effective amount for the purpose of a combination of a chlorate compound and a nitrate compound.

2. The method as recited in claim 1, wherein said chlorate compound is a metal chlorate.

3. The method as recited in claim 2, wherein said chlorate compound is NaClO₃.

4. The method as recited in claim 1, wherein said nitrate compound is a metal nitrate.

5. The method as recited in claim 4, wherein said nitrate compound is NaNO₃.

6. The method as recited in claim 4, wherein said nitrate compound is Ca(NO₃)₂ or Mg(NO₃)₂.

7. The method as recited in claim 1, wherein said aqueous medium comprises a wastewater medium.

8. The method as recited in claim 1, wherein the amount of chlorate compound is less than the amount of nitrate compound.
